(19) United States
(12) Patent Application Publication
(10) Pub. No.: US 2004/0150287 A1
(43) Pub. Date: Aug. 5, 2004

(54) Segmented stator and the winding of it

(76) Inventors: Sami Wainio, Helsinki (FI); Ilkka T Ikonen, Nummela (FI); Matti Poyhonen, Mustasaari (FI); Jiri Ahlvik, Vaasa (FI)

Correspondence Address: BIRCH STEWART KOLASCH & BIRCH, PO BOX 747, FALLS CHURCH, VA, 22040-0747, US

(21) Appl. No.: 10/475,805

(22) PCT Filed: Apr. 24, 2002
(86) PCT No.: PCT/FI02/00338

(30) Foreign Application Priority Data
Apr. 27, 2001 (FI) I20010886

(51) Int. Cl. H02K 1/18; H02K 1/28; H02K 1/12

(52) U.S. Cl. 310/218; 310/259

(57) ABSTRACT

A stator for synchronous motors with more than two poles, comprising a plurality of sectors (10) formed by lamination packs which are joined at their ends (11), forming as a whole a closed annular structure, at least one pole shoe (13) protruding from each one of the sectors (10). The ends of the stator define, at each connecting region (14), thanks to respective facing shaped portions (15), at least one tab (16) with mutually opposite undercuts (17), one for each end, the tabs (16) accommodate corresponding portions of an elastic connecting element (18) which surrounds the tab and rigidly couples the sectors.

### TECHNICAL FIELD

The present invention relates to a stator for synchronous motors having more than two poles.

### BACKGROUND ART

It is known that single-phase permanent-magnet synchronous motors are currently provided by means of a stator configuration S which is shaped like a tuning fork (see FIG. 1 of the accompanying drawings), which has been very successful thanks to its low cost arising from its extreme constructive simplicity.

The windings, not shown in FIG. 1, are formed on spools with winding machines which have a high production rate, can be easily automated and therefore have an unbeatable investment/productivity ratio.

The coils are then very easily fitted on the respective pole shoes of the stator.

Moreover, FIG. 1 clearly shows that the process for blanking the metal laminations that compose the stator pack minimizes waste, thanks to the tuning-fork geometry, which allows two contours to interpenetrate.

In synchronous motors having a stator with more than two poles, the structure is necessarily more complicated.

FIG. 2, for example, illustrates the diagram of a four-pole stator in which there is a ring A on the inside whereof there are four dovetail slots B for the interlocking insertion of complementarily shaped ends C of pole shoes D.

In this case also, the windings, not shown, are produced on spools by means of winding machines and the coils are fitted on the pole shoes D.

Finally, the pole shoes D are inserted in the ring A with an interlocking coupling.

In this case, construction of the stator is complicated, because the ring A becomes very expensive as it entails a large amount of waste in the blanking process, while the interlocking coupling of the pole shoes D with the ring A causes problems related both to coupling tolerances (if they are too small, assembly is particularly difficult, whereas if they are too large, one introduces a loss in the magnetic circuit and an insufficient structural solidity of the stator, with the risk of introducing unwanted vibrations) and to assembly, which must occur at right angles to the plane of the stator, with consequent complications in the assembly process.

In order to solve these problems, motors have been devised in which the stator (see FIG. 3) is constituted by a plurality of sectors E which are joined at their ends, forming as a whole a closed annular structure.

A pole shoe F protrudes from each sector E and is monolithic therewith.

The ends G are complementarily shaped, forming male-female interlocking couplings H, and constitute, as a whole, seats I for mutual fixing screws, not shown.

In this case, the monolithic annular element is eliminated, but there is still the need to interlock the last sector E by acting on a plane which is perpendicular to the stator plane, with the consequent coupling problems, although greater structural solidity is achieved by means of the screws.

The interlocking couplings H moreover introduce asymmetry problems which make it necessary to orientate the pack during assembly. The amount of waste is reduced with respect to the preceding case.

### DISCLOSURE OF THE INVENTION

The aim of the present invention is to provide a stator for synchronous motors having more than two poles which allows to fit coils wound beforehand on spools by means of winding machines in a simple manner on each one of the poles before assembly.

Within the scope of this aim, a consequent primary object is to provide a stator which avoids the need to orientate the components during mutual assembly.

Another object is to eliminate any kind of interlocking between the parts, so as to eliminate the problems related to the mechanical coupling tolerance in order to facilitate assembly.

Another important object is to minimize the amount of waste during the blanking process.

These and other objects which will become better apparent hereinafter are achieved by a stator for synchronous motors with more than two poles, comprising a plurality of sectors formed by lamination packs which are joined at their ends, forming as a whole a closed annular structure, at least one pole shoe protruding from each one of said sectors, characterized in that said ends define, at each connecting region, by respective facing shaped portions, at least one tab with opposite undercuts, one for each end, said tabs accommodating corresponding portions of an elastic connecting element which surrounds said tab and rigidly couples the sectors.

### BRIEF DESCRIPTION OF THE DRAWINGS

Further characteristics and advantages of the invention will become apparent from the detailed description of embodiments thereof, illustrated only by way of non-limitative example in the accompanying drawings, wherein:

FIG. 1 is a plan view of two laminations of a first conventional stator;

FIG. 2 is a perspective view of a second conventional stator pack;

FIG. 3 is a perspective view of a third conventional stator pack;

FIG. 4 is a plan view of a first embodiment of the pack of a stator according to the invention;

FIG. 5 is a perspective view of the stator pack of FIG. 4;

FIG. 6 is a plan view of a stator in a second embodiment of the invention;

FIG. 7 is a plan view of a third embodiment of the pack of a stator according to the invention;

FIG. 8 is a perspective view of the stator pack of FIG. 7;

FIG. 9 is a view of the blanking lines of a portion of metal plate from which the components of the pack of FIG. 7 are obtained.

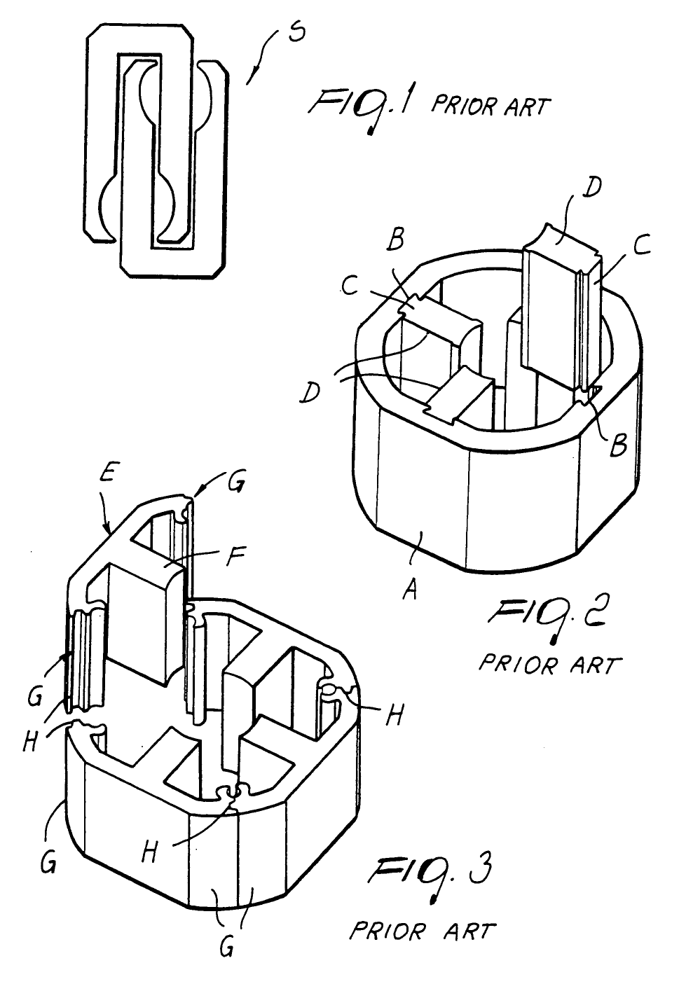

### WAYS OF CARRYING OUT THE INVENTION

With reference to the above cited FIGS. 4 and 5, a stator for synchronous motors having more than two poles comprises, in a first embodiment, four sectors 10 formed by lamination packs which are joined at their ends 11, forming as a whole a closed annular structure 12, which in this case has a substantially octagonal shape.

In particular, each sector 10 forms, with its middle portion, one wall of the annular structure and forms, with its ends, respective wall portions which are inclined at 45 sexagesimal degrees with respect to the rest.

At least one pole shoe 13 protrudes toward the center of the annular structure 12 in the middle region of each sector 10.

According to the invention, the ends 11, at each mutual coupling region 14, rest against each other edge to edge by means of flat surfaces and define, together with respective facing shaped portions 15, at least one tab 16, which has a circular profile in the case being considered.

The tab 16 can be internal and/or external (as shown by the dashed lines of FIG. 4).

As a whole, each sector 10 is symmetrical with respect to a longitudinal middle plane.

The region where the portions 15 of the tab 16 connect to the corresponding ends 11 is, as a whole, narrower than the diameter of the tab 16, so that mutually opposite undercuts 17 (one for each end 11) are formed which accommodate corresponding end portions of an elastic coupling element which is constituted, in this case, by a spring 18 made of metal plate which completely surrounds said tab 16 and rigidly couples the sectors.

The force with which the spring 18 acts depends of course on the material that composes it and on its geometry.

In practice, the undercuts 17 form inclined planes and/or dovetail elements on which longitudinal edges 19 of the spring 18 act; the spring is shaped appropriately, in this case, like a longitudinally open cylinder.

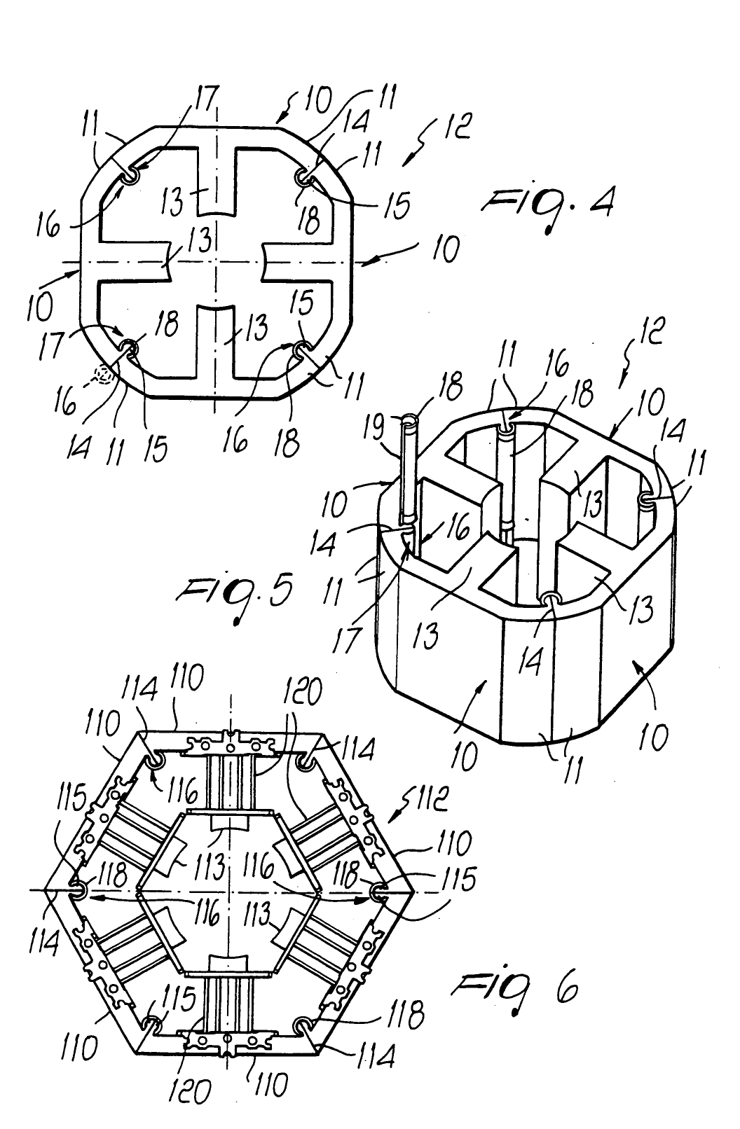

With reference now to the above cited FIG. 6, a stator for a six-pole motor is illustrated which is constituted by six sectors 110, each of which forms a wall of an annular structure 112 which has a hexagonal contour.

Each sector 110 has a pole shoe 113 in its middle region; in this case, the spool 120 of the corresponding winding of the pole shoe, not shown for the sake of simplicity, is shown inserted.

In this case also, the ends 111 are joined by means of facing flat surfaces 114 by virtue of contoured portions 115 which form tabs 116 having a circular profile and on which coupling springs 118 act.

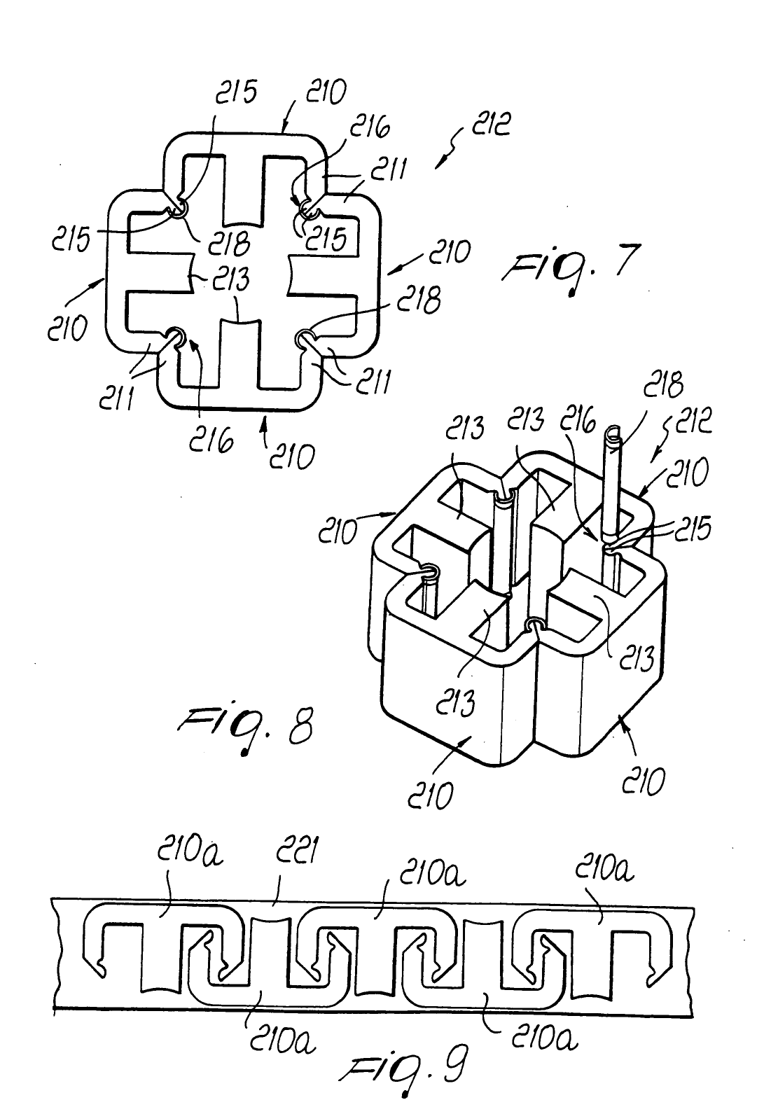

With reference now to the above cited FIGS. 7 to 9, in another embodiment the stator of a four-pole motor is composed of four sectors 210, whose ends 211 lie at right angles to the middle regions provided with the pole shoes 213.

The sectors 210 are therefore E-shaped and form, as a whole, a closed cross-shaped annular structure 212.

Mutual coupling occurs in the same manner as in the preceding cases, with contoured portions 215 which form tabs 216 which have a circular profile and on which springs 218 shaped like a longitudinally open cylinder are fitted.

FIG. 9 illustrates the blankings produced on a portion of metal plate 221 from which the components 210a (laminations) of each sector 210 are obtained.

The E-shaped figures perfectly interpenetrate, providing considerable savings in raw material and optimizing the process.

In practice it has been observed that in all the embodiments the stator according to the invention has achieved the intended aim and objects.

The provision of a composite outer annular structure of the stator in fact allows to provide the windings separately from said stator and then fit them on the pole shoes before assembly.

The perfect symmetry of each sector with respect to the others avoids the need to orientate the parts for mutual assembly.

The springs which, thanks to their elasticity, adapt to the shapes and dimensions of the tabs, eliminate the problems in terms of coupling tolerances between the parts.

Moreover, optimization of the shapes of each sector ensures a reduction of the blanking waste of the laminations that compose the stator, providing considerable savings in raw material and optimizing the process.

The invention thus conceived is susceptible of numerous modifications and variations, all of which are within the scope of the appended claims.

All the details may furthermore be replaced with other technically equivalent elements.

In practice, the materials used, so long as they are compatible with the is contingent use, as well as the dimensions, may be any according to requirements.

The disclosures in Italian Patent Application No. PD99A000130 from which this application claims priority are incorporated herein by reference.

1. Method for winding the stator of an electric machine (5), said stator consisting of separate stator segments (52) fitted around a rotor, said stator segments being provided with winding slots (53) for windings (54), in which method the stator is wound on a winding jig,
wherein the stator segments are placed in the winding jig with their winding slots facing outwards during the winding operation, characterized in that,
the stator segments are stator corner segments that can be fitted in the winding jig close to each other so that they form a substantially rectangular structure, and
all the stator segments are wound with one continuous winding wire (58) in all stator segments by fitting continuous coils of winding wire (58) into the winding slots.

2. Stator of an electric machine, said stator consisting of separate stator segments (52) fitted around a rotor, said stator segments being provided with winding slots (53) for windings (54), which stator segments can be set with the winding slots facing outwards to form a continuous structure, characterized in that the stator segments are stator corner stator segments that can be fitted in a winding jig close to each other to form a substantially rectangular structure and that the stator segments have oblique side walls (55) so that they can be set close to each other with the winding slots facing outwards to form a continuous structure.

3. Stator as defined in claim 2, said stator consisting of stator plates placed one upon the other, characterized in that each plate is provided with machined structural shapes interlocking the plates with each other so that the separate plates can be assembled to form stator segments without welding or a corresponding fastening technique.
